(19) United States
(12) Patent Application Publication
(10) Pub. No.: US 2019/0129942 A1
(43) Pub. Date: May 2, 2019

(54) METHODS AND SYSTEMS FOR AUTOMATICALLY GENERATING REPORTS FROM SEARCH RESULTS

(71) Applicant: NORTHERN LIGHT GROUP, LLC, Boston, MA (US)

(72) Inventor: C. David Seuss, Charlestown, MA (US)

(21) Appl. No.: 16/174,988

(22) Filed: Oct. 30, 2018

Related U.S. Application Data
(60) Provisional application No. 62/578,734, filed on Oct. 30, 2017.

(51) Int. Cl. G06F 17/27; G06F 17/30

(52) U.S. Cl. CPC G06F 17/2785; G06F 17/30011; G06F 17/2705; G06F 17/30684; G06F 17/30719

(57) ABSTRACT

A method for generating a document summary includes identifying, in a document, a plurality of candidate summary sentences satisfying predefined criteria; determining at least one content feature of the document; generating a graph of relationships among the plurality of sentences; ordering the plurality of sentences based on at least one relationship involving a respective sentence; and generating a document summary from the ordered sentences, the document summary including the sentences most related to other sentences. A method for generating a search report summary includes generating a meta-document from a plurality of document summaries; determining at least one content feature of the meta-document; generating a graph of relationships among the meta-document sentences; ordering the meta-document sentences based on at least one relationship involving a respective meta-document sentence; and generating a meta-document summary from the ordered meta-document sentences, the meta-document summary including the meta-document sentences most related to other meta-document sentences.

### CROSS REFERENCE TO RELATED APPLICATIONS

This application claims priority under 35 U.S.C. § 119(e) to U.S. Provisional Application Ser. No. 62/578,734, titled “METHODS AND SYSTEMS FOR AUTOMATICALLY GENERATING DOCUMENT SUMMARIES,” filed Oct. 30, 2017, which is incorporated herein by reference in its entirety.

### BACKGROUND

### Technical Field

The technical field of this disclosure relates generally to content analysis and, more specifically, to semantic analysis of documents to automatically generate a summary of one or more documents.

### Discussion

Computerized tools for semantic analysis are able to process large bodies of documents to identify topics discussed therein. Yet there is currently no known method for automatically summarizing documents—let alone a body of documents—in a manner that is accessible and useful to a reader interested in those topics. Manually created summaries, drafted by humans who are familiar with the documents, are known. Such summaries are labor and time-intensive, though, and may be prone to human error and biases, and depend on the user being able to correlate the document with particular topics or themes, even where those concepts are not explicitly referenced at times.

Known methods for generating summaries involve attempting to select a representative or summary-like passage of documents based on some content appearing within the passage. Yet there is no guarantee that a passage referencing a topic will be particularly useful in summarizing the topic; the passage in its entirety may be irrelevant or, worse still, misleading regarding the topic when taken out of context.

When it comes to generating a single summary of a body of documents, the drawbacks of these known methods are exacerbated. Manual techniques require a human author to read a possibly large number of documents, keep track of which topics and themes are important and which are not, and synthesize this learning into a manual summary where human error and biases may be even more pronounced. When documents are removed, replaced, added, or modified, the summary must be updated, regenerated, or otherwise maintained. Furthermore, approaches that rely on identifying a representative passage from a single document are also unhelpful in generating a summary of a collection of documents.

### SUMMARY

Presently disclosed embodiments address the drawbacks of manual and other known summary generation techniques by automating the generation of document summaries and search reports.

In one aspect, document summaries can be generated by selecting and ordering “summary-worthy” sentences from the document that may be candidates for inclusion in the document summary. As a preliminary matter, the sentences in a document can be screened by their structure and linguistic characteristics to identify those that may be good candidates for inclusion in an automated summary, and to exclude those sentences not suitable for inclusion. Such screening can be performed automatically and with or without regard to the subject matter. For example, sentence structure and grammar, sentence length, and defined “stop strings” previously identified as grounds for exclusion can be used to isolate summary-worthy sentences for further processing.

The summary-worthy sentences can be examined to identify features (e.g., topics or syntactic structures) of interest within the document. A relationship between one sentence and another can be identified and weighed according to the number of features that the sentences have in common. In this manner, relationships among every pair of sentences in the document can be measured and stored by the computer in a graph data structure. The most important sentences in the document for purposes of generating a summary can then be identified according to each sentence's “relatedness” to other sentences. Relatedness may be determined by the number and/or strength of relationships between a given sentence and the other sentences in the document, as well as the importance of a feature represented by a relationship. For example, a sentence that includes three features (e.g., topics) may be highly related to a number of other sentences that also reference one or more of those features, particularly where one or more of the topics have been determined to be of particular interest by either the automated process or a human operator.

The summary-worthy sentences may be ordered in a computer memory according to their relatedness, with the most highly related documents being ranked highest. A document summary can then be crafted by assembling the summary-worthy sentences, in order of relatedness or by some other order such as their sequence in the original document, until a defined length of the summary or other limit has been reached.

In another aspect, a summary search report summarizing a body of documents (e.g., a list of documents) can be automatically generated. Individual document summaries of the body of documents may be aggregated into a “meta-document” made up of all of the sentences from the individual document summaries. The document summaries used to generate the meta-document may be generated automatically as discussed above, or may be generated manually or by other methods. The meta-document sentences can then be examined to identify features (e.g., topics or syntactic structures) of interest within the meta-document (i.e., the document summaries). A relationship between one meta-document sentence and another can be identified and weighed according to the number of features that the sentences have in common. In this manner, relationships among every pair of sentences in the meta-document can be measured and stored by the computer in a graph data structure.

The most important sentences in the document can then be identified according to each sentence's “relatedness” to other sentences. Relatedness may be determined by the number and/or strength of relationships between a given sentence and the other sentences in the meta-document, as well as the importance of a feature represented by a relationship. The sentences may be ordered in a computer memory according to their relatedness, with the most highly related sentences being ranked highest. A search report can then be crafted by selecting the meta-document sentences, in order of relatedness, for inclusion in the search report. The sentences may then be incorporated into the search report in a particular order. For example, where the search report is intended to summarize an ordered list of documents (e.g., search results from a search engine query), the highly-related sentences from the meta-document may be incorporated into the search report according to the position, in the ordered list, of the document from which the highly-related sentence originated. The search report may be assembled in this way until a defined length of the summary or other limit has been reached.

According to one aspect, a computer-based method for automatically generating a summary of a document includes identifying, in a document, a plurality of candidate summary sentences satisfying one or more predefined criteria; determining, from the plurality of candidate summary sentences, at least one content feature of the document; generating a graph of a plurality of relationships among the plurality of candidate summary sentences, each respective relationship in the plurality of relationships representing at least one content feature common to two candidate summary sentences; ordering the plurality of candidate summary sentences based on at least one relationship involving a respective candidate summary sentence; and generating a document summary from the ordered plurality of candidate summary sentences, the document summary including the candidate summary sentences most related to other candidate summary sentences in the plurality of candidate summary sentences.

According to one embodiment, ordering the plurality of candidate summary sentences based on the at least one relationship involving the respective candidate summary sentence includes identifying at least one topic in a related sentence of the respective candidate summary sentence; and assigning a prestige score to the respective candidate summary sentence based on an importance of the at least one topic in the related sentence.

According to another embodiment, the one or more predefined criteria include one of a requirement that a candidate summary sentence has a verb at the root of a parsing diagram of the sentence, a requirement that the candidate summary sentence has a noun or pronoun as the direct object, a requirement that the candidate summary sentence not include one or more defined substrings, and a requirement that the candidate summary sentence does include at least one defined substring. According to yet another embodiment, the at least one content feature is at least one of an entity, concept, or linguistic structure.

According to another embodiment, the graph comprises a plurality of nodes and edges, each respective node representing a candidate summary sentence and each respective edge representing a relationship between a first candidate summary sentence and a second candidate summary sentence. According to a further embodiment, each respective edge represents a strength of the relationship between the first candidate summary sentence and the second candidate summary sentence. According to a still further embodiment, the strength of the relationship is determined based at least in part on a number of content features common to the first candidate summary sentence and the second candidate summary sentence. According to yet another embodiment, the strength of the relationship is determined based at least in part on an importance of a content feature common to the first candidate summary sentence and the second candidate summary sentence.

According to one embodiment, generating the document summary from the ordered plurality of candidate summary sentences comprises including the candidate summary sentences in an order in which the candidate summary sentences appear in the document.

According to another aspect, a computer-based method for generating a search report summary includes identifying a plurality of documents relating to a topic; generating a meta-document from a plurality of document summaries of the plurality of documents, the meta-document comprising a plurality of meta-document sentences; determining at least one content feature of the meta-document; generating a graph of a plurality of relationships among the plurality of meta-document sentences, each respective relationship in the plurality of relationships representing at least one content feature common to two meta-document sentences; ordering the plurality of meta-document sentences based on at least one relationship involving a respective meta-document sentence; and generating a meta-document summary from the ordered plurality of meta-document sentences, the meta-document summary including the meta-document sentences most related to other meta-document sentences in the plurality of meta-document sentences.

According to one embodiment, ordering the plurality of meta-document sentences includes identifying at least one topic in a related sentence of the respective meta-document sentence; and assigning a prestige score to the respective meta-document sentence based on an importance of the at least one topic in the related sentence. According to another embodiment, identifying the plurality of documents relating to the topic includes identifying documents having a relevance to the topic at least as high as a defined relevance threshold. According to yet another embodiment, the at least one content feature is at least one of an entity, concept, or linguistic structure.

According to another embodiment, the graph comprises a plurality of nodes and edges, each respective node representing a meta-document sentence and each respective edge representing a relationship between a first meta-document sentence and a second meta-document sentence. According to a further embodiment, each respective edge represents a strength of the relationship between the first meta-document sentence and the second meta-document sentence. According to a still further embodiment, the strength of the relationship is determined based at least in part on a number of content features common to the first meta-document sentence and the second meta-document sentence. According to a further embodiment, the strength of the relationship is determined based at least in part on an importance of a content feature common to the first meta-document sentence and the second meta-document sentence.

According to one embodiment, generating the document summary from the ordered plurality of candidate summary sentences comprises including the candidate summary sentences in an order in which the candidate summary sentences appear in the document.

According to another aspect, a computer system for automatically generating a summary of a document includes a processor; and a memory communicatively coupled to the processor and comprising instructions that when executed by the processor cause the processor to identify, in a document stored in the memory, a plurality of candidate summary sentences satisfying one or more predefined criteria; determine, from the plurality of candidate summary sentences, at least one content feature of the document; generate a graph of a plurality of relationships among the plurality of candidate summary sentences, each respective relationship in the plurality of relationships representing at least one content feature common to two candidate summary sentences; order the plurality of candidate summary sentences based on at least one relationship involving a respective candidate summary sentence; and generate a document summary from the ordered plurality of candidate summary sentences, the document summary including the candidate summary sentences most related to other candidate summary sentences in the plurality of candidate summary sentences.

According to one embodiment, the processor is further configured to order the plurality of candidate summary sentences based on the at least one relationship involving the respective candidate summary sentence by being configured to identify at least one topic in a related sentence of the respective candidate summary sentence; and assign a prestige score to the respective candidate summary sentence based on an importance of the at least one topic in the related sentence.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a flow chart of a process for generating a document summary according to one embodiment;

FIG. 2 is a flow chart of a process for generating a search summary report according to one embodiment;

FIG. 3 is a block diagram of one example of a computer system on which aspects and embodiments of this disclosure may be implemented; and

FIG. 4. is another block diagram of one example of a computer system on which aspects and embodiments of this disclosure may be implemented.

### DETAILED DESCRIPTION

Embodiments of the present disclosure relate to systems and methods for automatically generating summaries of one or more documents by identifying the sentences in those documents most related (by concept or otherwise) to other sentences in the document, and incorporating those sentences into the document summary. Similarly, a search report summary can be automatically generated to summarize a body of documents. Individual document summaries may be aggregated into a meta-document; the individual document summaries may be generated according to methods discussed herein, or according to other methods. The search summary report is generated by identifying the sentences in the meta-document most related to other sentences in the meta-document, and incorporating those sentences into the search summary report.

### Automatic Generation of Document Summaries

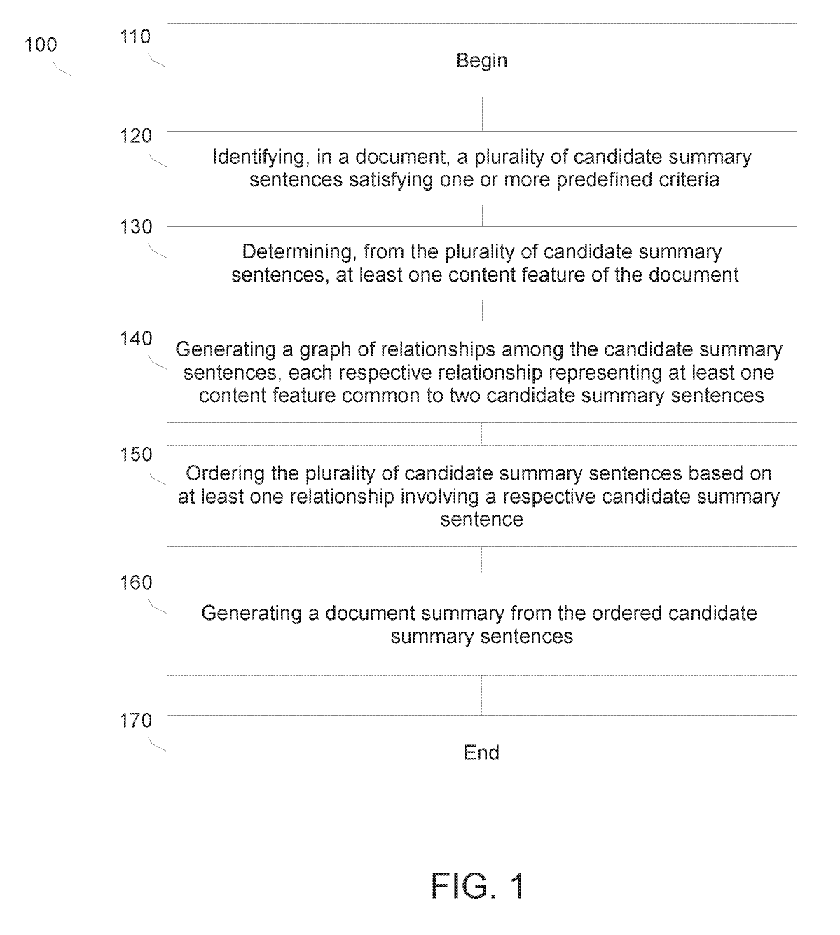

An exemplary method 100 for generating a document summary is shown in FIG. 1. The method includes an act 120 of identifying, in a document, a plurality of candidate summary sentences satisfying one or more predefined criteria; an act 130 of determining, from the plurality of candidate summary sentences, at least one content feature of the document; an act 140 of generating a graph of a plurality of relationships among the plurality of candidate summary sentences, each respective relationship in the plurality of relationships representing at least one content feature common to two candidate summary sentences; an act 150 of ordering the plurality of candidate summary sentences based on at least one relationship involving a respective candidate summary sentence; and an act 160 of generating a document summary from the ordered plurality of candidate summary sentences, the document summary including the candidate summary sentences most related to other candidate summary sentences in the plurality of candidate summary sentences.

At step 110, method 100 begins.

As an initial step, the document may be processed to remove content not relevant to identifying summary-worthy sentences. For example, where the document is derived from a webpage, the document may be parsed to remove HTML or XML code, other formatting, embedded advertisements, and the like.

At step 120, candidate summary sentences satisfying one or more predefined criteria are identified in a document. Candidate summary sentences may be those sentences having or containing a grammatical structure, length, format, or other aspect that has been identified as being characteristic of sentences suitable for use in a summary document. As discussed below, summary sentences used in automatically generating a document summary are selected from the candidate summary sentences.

In one example, the one or more criteria may include particular grammatical structures (such as a verb root and noun or pronoun direct object of the sentence) being present in the candidate summary sentences. Grammatical or sentence structures may be recognized by analyzing the document using a parsing or syntax-oriented tools such as SyntaxNet by Google Inc. (Mountain View, Calif.) or Wordnet by Princeton University (Princeton N.J.). Such tools may be adapted to identify and tag the parts of speech within a sentence or to determine if a text string is a known word. In another example, the presence of certain words or phrases may be used to qualify or disqualify candidate summary sentences. In some examples, “stop words” or phrases” having a known low value for summarizing the document (e.g., “click here” or “Like us on Facebook”), or other features (bullet point lists) may indicate that the substance of the sentence is not summary-worthy. In another example, the length of the sentence may indicate that the sentence is too long to be included in an automated document summary. In another example, the length of the sentence or the presence of formatting element (such as list item identifiers) may indicate that that the sentence is of a type (e.g., a list item) that is not suited for inclusion in a document summary.

At step 130, at least one content feature of the document is determined from the plurality of candidate summary sentences. The content feature may represent a concept, entity, or topic or subject as represented by one or more syntactic structures in the document (e.g., groupings of words). Such syntactic structures may be defined by the presence and/or proximity of one or more terms, which may use wildcard characters. Content features may include the syntactic structures themselves, as well. In one embodiment, the content feature may be a meaning-loaded entity (MLE) as described in U.S. Pat. No. 7,877,344, issued Jan. 25, 2011, titled “METHOD AND APPARATUS FOR EXTRACTING MEANING FROM DOCUMENTS USING A MEANING TAXONOMY COMPRISING SYNTACTIC STRUCTURES,” which is hereby incorporated by reference in its entirety. In some embodiments, a limit may be imposed on the number of content features to be identified in the candidate summary sentences. For example, a threshold or cutoff may be applied, with only content features appearing in more than a certain percentage of sentences being identified for purposes of the remaining steps. In another example, only the top x number of content features (by apparent importance or occurrence frequency) may be identified.

At step 140, a graph of a plurality of relationships among the plurality of candidate summary sentences is generated. Each respective relationship in the plurality of relationships represents at least one content feature common to two candidate summary sentences. The graph may be represented as having a number of nodes connected to one another by edges. Each node represents a candidate summary sentence, and each edge represents a relationship between two candidate summary sentences. In one example, the presence of an edge between two candidate summary sentences may indicate that the two sentences contain some number of overlapping (i.e., common) content features. In another example, the edge may have an associated “weight” value representing the strength or depth of the relationship between the two candidate summary sentences. For example, values stored in association with an edge may represent the number of overlapping content features between the two candidate summary sentences, or the strength or relative importance of the overlapping content features. In some embodiments, the graph may be generated using LexRank (available from GitHub), Latent Semantic Indexing, or other libraries or techniques.

At step 150, the plurality of candidate summary sentences is ordered based on at least one relationship involving a respective candidate summary sentence. The ordering may be based on the relatedness of each candidate summary sentence to the other candidate summary sentences in the document, with those documents most related to others given the highest rank in the ordering. Relatedness may be determined by the number and strength of edges connecting a candidate summary sentence to all other sentences in the document. A high number and/or weight of edges for a particular candidate summary sentence suggests that one sentence may discuss a relatively high number of (possibly) important content features, thereby suggesting that the candidate summary sentence may provide a good summary or overview of those topics and/or how they relate to one another.

In some embodiments, the conceptual importance or “prestige” of the related sentences—the nodes of the graph—may also be taken into account when determining the relatedness of sentences. For purposes of evaluating the relatedness of a sentence to other sentences in the document, a related sentence that discusses a relatively important content topic may accord the sentence being evaluated with a higher prestige score than a related sentence that discusses a relatively less important content topic. The relative importance of content topics may be determined from a training set, and used to assign prestige scores to nodes. For example, the overall frequency of occurrences of a topic in a corpus of training documents may be used to determine a relative importance or “prestige” of each topic, with more frequently-discussed topics being considered more important. That relative importance or prestige may then be considered when the determining the relevance of a sentence discussing that topic in the “live” set of documents.

The relative importance of content topics may also be determined with reference to the location in the document and/or document metadata of the text relating to the content topic. Topics discussed in a title or abstract of a document may be presumed to be more important than those appearing in the middle of the document, for example.

At step 160, a document summary is generated from the candidate summary sentences most related to other candidate summary sentences in the document. The most highly related sentences (as determined in step 150) may be collected and aggregated until their collective length reaches or exceeds a particular threshold set for document summaries. In some embodiments, the prestige score of a sentence's relationship-partner sentences is also taken into account. For example, a document summary may be generated from the candidate summary sentences with the most relationships centered on the most important topics with the most prestigious relationship partners. For example, the most related sentence, the second most related sentence, and so on may be selected for inclusion in the summary until their total length reaches a defined limit (e.g., 200 characters), at which point no further candidate summary sentences are selected for inclusion.

The document summary is then assembled from the selected candidate summary sentences. In one embodiment, the actual order of the selected candidate summary sentences within the summary is determined by their relative ordering in the document for which the summary is being generated—i.e., the selected candidate summary sentence that appears earlier in the document than the other selected candidate summary sentences would be the first sentence of the document summary, and so forth.

At step 170, the method ends.

### Automatic Generation of Search Summary Reports

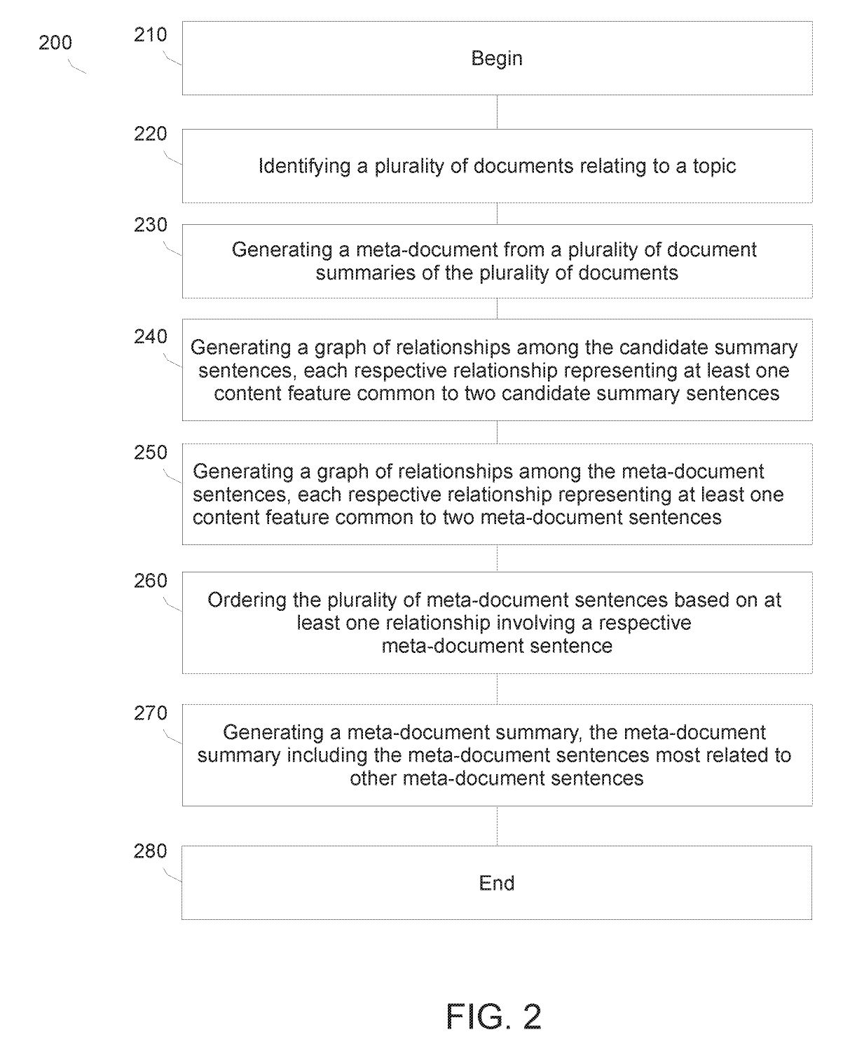

An exemplary method 200 for generating a search summary report is shown in FIG. 2. The method includes an act 220 of identifying a plurality of documents relating to a particular topic; an act 230 of generating a meta-document from a plurality of document summaries of the plurality of documents, the meta-document comprising a plurality of meta-document sentences; an act 240 of determining at least one content feature of the meta-document; an act 250 of generating a graph of a plurality of relationships among the plurality of meta-document sentences, each respective relationship in the plurality of relationships representing at least one content feature common to two meta-document sentences; an act 260 of ordering the plurality of meta-document sentences based on at least one relationship involving a respective meta-document sentence; and an act 270 of generating a meta-document summary from the ordered plurality of meta-document sentences, the meta-document summary including the meta-document sentences most related to other meta-document sentences in the plurality of meta-document sentences.

As part of the process of automatically generating a search summary report, a set of documents may be identified as having some relevance to a topic of interest. In some embodiments, these documents may be identified, ranked, and scored according to their relevance to the topic, with the most relevant being stored in a topical document list. In one example, topical documents may be identified in response to a query submitted to a search engine.

Topical documents may be selected for inclusion according to any number of criteria. In one example, a specifically-sized subset of the total set documents is included in the topical document list, such as the x % of total documents, or the top n documents. In another example, documents having a relevance score over a particular threshold may be included in the topical document list. In another example, documents from a particular time period (e.g., the last two weeks), or documents selected or scored by a human user, may be included. Once the topical document list has been assembled, the search summary report is automatically generated.

At step 210, method 200 begins.

At step 220, a meta-document is generated from a plurality of document summaries of the plurality of documents. The meta-document may include all of the sentences of all of the document summaries of the documents on the topical document list.

At step 230, at least one content feature of the meta-document is determined. As discussed above, a content feature may represent a concept, entity, or topic or subject as represented by one or more syntactic structures in the meta-document (e.g., groupings of words). Such syntactic structures may be defined by the presence and/or proximity of one or more terms, which may use wildcard characters. Content features may include the syntactic structures themselves, as well. Content features may be identified through the use of machine learning tool that have been trained on sets of documents known to contain certain content features. Such training sets may be created manually by a knowledgeable user. In one example, documents to be included in training sets may be identified with reference to MLEs that have been tagged in the document.

In some embodiments, a limit may be imposed on the number of content features to be identified in the candidate summary sentences. For example, a threshold or cutoff may be applied, with only content features appearing in more than a certain percentage of sentences being identified for purposes of the remaining steps. In another example, only the top x number of content features (by apparent importance or occurrence frequency) may be identified.

At step 240, a graph of a plurality of relationships among the plurality of meta-document sentences is generated. Each respective relationship in the plurality of relationships represents at least one content feature common to two meta-document sentences. The graph may be represented as having a number of nodes connected to one another by edges. Each node represents a sentence of the meta-document, and each edge represents a relationship between two sentences. In one example, the presence of an edge between two meta-document sentences may indicate that the two sentences contain some number of overlapping (i.e., common) content features. In another example, the edge may have an associated “weight” value representing the strength or depth of the relationship between the two sentences. Nodes of the graph representing related sentences may also have a weight reflecting the prestige score of those sentences, as determined by the relative important of the content and/or topics discussed in those related sentences. For example, values stored in association with an edge may represent the number of overlapping content features between the two sentences, or the strength or relative importance of the overlapping content features. In some embodiments, the graph may be generated using LexRank, Latent Semantic Indexing, or other libraries or techniques.

At step 250, the plurality of meta-document sentences is ordered based on at least one relationship involving a respective meta-document sentence. The ordering may be based on the relatedness of each meta-document sentence to the other meta-document sentences in the meta-document, with those sentences most related to others given the highest rank in the ordering. Relatedness may be determined by the number and strength of edges connecting a meta-document sentence to all other sentences in the meta-document. A high number and/or weight of edges for a particular meta-document sentence suggests that particular sentence may discuss a relatively high number of (possibly) important content features, thereby suggesting that the meta-document sentence may provide a good summary or overview of those content features found in the documents on which the meta-document is based, and/or how those content features relate to one another.

At step 260, a meta-document summary (i.e., a search summary report) is generated from the ordered plurality of meta-document sentences. The meta-document summary includes the meta-document sentences most related to other meta-document sentences in the plurality of meta-document sentences. The most highly related sentences (as determined in step 250) may be collected and aggregated until their collective length reaches or exceeds a particular threshold set for search summary reports. For example, the most related sentence, the second most related sentence, and so on may be selected for inclusion in the summary until their total length reaches a defined limit (e.g., 500 characters), at which point no further meta-document summary sentences are selected for inclusion.

The search summary report is then assembled from the selected candidate summary sentences. In one embodiment, the actual order of the meta-document sentences within the search summary report is determined by the ordering of the documents in the topical document list; sentences may be included in the order in which the document from which they are derived appears in the topical document list. Other methods could also be used for ordering the sentences in the search summary report, such as ordering by the strength of the edges between the sentences, calculating the importance of each sentence, and using that importance for ordering the sentences. When several document summaries are used to generate the search summary report, sentences from those document summaries may be selected according to an ordering of the documents themselves. In other words, document summaries may be ordered based on an attribute of the underlying document, and the search summary report may be generated from the ordered document summaries. Documents may be ordered based on such factors as their relevance to a search query, or according to their creation or publication date. In some examples, a two-step ordering of selected candidate summary sentences may be performed. In a first step, candidate sentences are grouped by document in the order of the list of documents. In a second step, the candidate sentences are ordered within the document group according to how they appear in the document.

The method ends at step 270.

The search summary report may be transmitted to another component of the computer system, or to another system altogether via a computer network, for further processing, storage, or display to a user. In one example, the search summary report may be presented to a user viewing ordered search results, such as those returned by a traditional search engine. In that example, the search summary report may be presented in a user interface proximate to the search results. As discussed, the sentences of the search summary report may be ordered so as to track the order of the documents in the search results; sentences from documents are presented in the order in which the documents appear in the results.

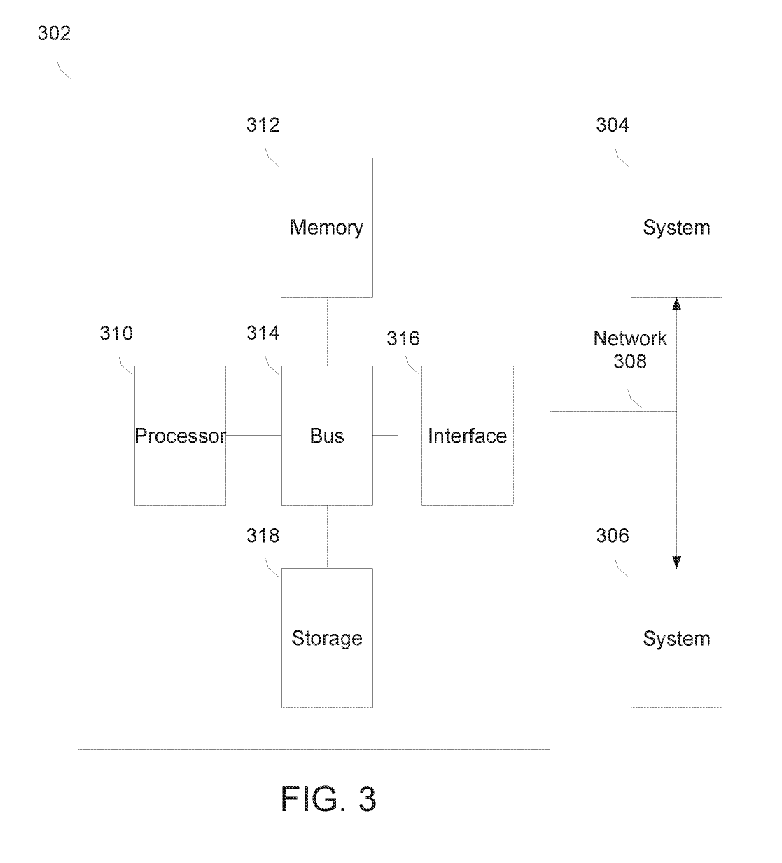

FIG. 3 is a block diagram of a distributed computer system 300, in which various aspects and functions discussed above may be practiced. The distributed computer system 300 may include one or more computer systems. For example, as illustrated, the distributed computer system 300 includes three computer systems 302, 304, and 306. As shown, the computer systems 302, 304 and 306 are interconnected by, and may exchange data through, a communication network 308. The network 308 may include any communication network through which computer systems may exchange data. To exchange data via the network 308, the computer systems 302, 304, and 306 and the network 308 may use various methods, protocols and standards including, among others, token ring, Ethernet, Wireless Ethernet, Bluetooth, radio signaling, infra-red signaling, TCP/IP, UDP, HTTP, FTP, SNMP, SMS, MMS, SS7, JSON, XML, REST, SOAP, CORBA HOP, RMI, DCOM and Web Services.

According to some embodiments, the functions and operations discussed for producing a three-dimensional synthetic viewpoint can be executed on computer systems 302, 304 and 306 individually and/or in combination. For example, the computer systems 302, 304, and 306 support, for example, participation in a collaborative network. In one alternative, a single computer system (e.g., 302) can generate the three-dimensional synthetic viewpoint. The computer systems 302, 304 and 306 may include personal computing devices such as cellular telephones, smart phones, tablets, “fablets,” etc., and may also include desktop computers, laptop computers, etc.

Various aspects and functions in accord with embodiments discussed herein may be implemented as specialized hardware or software executing in one or more computer systems. In one embodiment, computer system 302 is a personal computing device specially configured to execute the processes and/or operations discussed above. As depicted, the computer system 302 includes at least one processor 310 (e.g., a single core or a multi-core processor), a memory 312, a bus 314, input/output interfaces (e.g., 316) and storage 318. The processor 310, which may include one or more microprocessors or other types of controllers, can perform a series of instructions that manipulate data. As shown, the processor 310 is connected to other system components, including a memory 312, by an interconnection element (e.g., the bus 314).

The memory 312 and/or storage 318 may be used for storing programs and data during operation of the computer system 302. For example, the memory 312 may be a relatively high performance, volatile, random access memory such as a dynamic random access memory (DRAM) or static memory (SRAM). In addition, the memory 312 may include any device for storing data, such as a disk drive or other non-volatile storage device, such as flash memory, solid state, or phase-change memory (PCM). In further embodiments, the functions and operations discussed with respect to generating and/or rendering synthetic three-dimensional views can be embodied in an application that is executed on the computer system 302 from the memory 312 and/or the storage 318. For example, the application can be made available through an “app store” for download and/or purchase. Once installed or made available for execution, computer system 302 can be specially configured to execute the functions associated with producing synthetic three-dimensional views.

Computer system 302 also includes one or more interfaces 316 such as input devices (e.g., camera for capturing images), output devices and combination input/output devices. The interfaces 316 may receive input, provide output, or both. The storage system 318 may include a computer-readable and computer-writeable nonvolatile storage medium in which instructions are stored that define a program to be executed by the processor. The storage system 318 also may include information that is recorded, on or in, the medium, and this information may be processed by the application. A medium that can be used with various embodiments may include, for example, optical disk, magnetic disk or flash memory, SSD, among others. Further, aspects and embodiments are not to a particular memory system or storage system.

In some embodiments, the computer system 302 may include an operating system that manages at least a portion of the hardware components (e.g., input/output devices, touch screens, cameras, etc.) included in computer system 302. One or more processors or controllers, such as processor 310, may execute an operating system which may be, among others, a Windows-based operating system (e.g., Windows NT, ME, XP, Vista, 7, 8, or RT) available from the Microsoft Corporation, an operating system available from Apple Computer (e.g., MAC OS, including System X), one of many Linux-based operating system distributions (for example, the Enterprise Linux operating system available from Red Hat Inc.), a Solaris operating system available from Oracle Corporation, or a UNIX operating systems available from various sources. Many other operating systems may be used, including operating systems designed for personal computing devices (e.g., iOS, Android, etc.) and embodiments are not limited to any particular operating system.

The processor and operating system together define a computing platform on which applications (e.g., “apps” available from an “app store”) may be executed. Additionally, various functions for generating and manipulating images may be implemented in a non-programmed environment (for example, documents created in HTML, XML or other format that, when viewed in a window of a browser program, render aspects of a graphical-user interface or perform other functions). Further, various embodiments in accord with aspects of the present invention may be implemented as programmed or non-programmed components, or any combination thereof. Various embodiments may be implemented in part as MATLAB functions, scripts, and/or batch jobs. Thus, the invention is not limited to a specific programming language and any suitable programming language could also be used.

Although the computer system 302 is shown by way of example as one type of computer system upon which various functions may be practiced, aspects and embodiments are not limited to being implemented on the computer system shown in FIG. 3. Various aspects and functions may be practiced on one or more computers or similar devices having different architectures or components than that shown in FIG. 3.

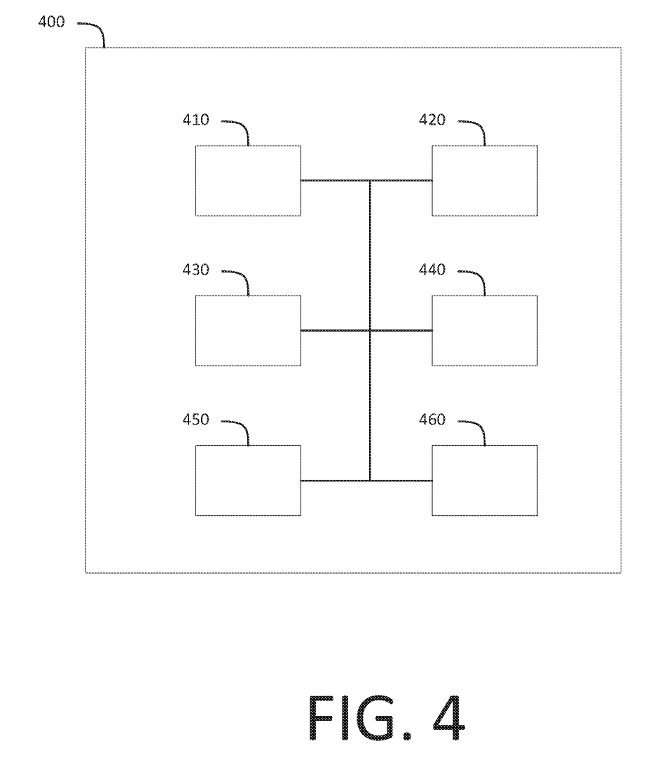

FIG. 4 illustrates a functional block diagram of a system 400 for automatically generating reports from search results according to some embodiments. The system 400 may be used to facilitate the processes detailed above. Any of the modules recited below may be implemented in customized software code or using existing software including a GUI, email, FTP, batch system interface, database system data movement tools, middleware, search engines such as Fast, Autonomy, Google Search Appliance, Microsoft SharePoint Search, and/or Lucene, scanning with optical character recognition (OCR), any combination thereof, or otherwise. Moreover, the modular structure and content recited below is for exemplary purposes only and is not intended to limit the application to the specific structure shown in FIG. 4. As will be apparent to one of ordinary skill in the art, many variant modular structures can be architected without deviating from the present application. The particular modular arrangement presented in FIG. 4 is depicted for illustrative purposes.

System 400 may include one or more subsystems and components, including a processor 410, a document database 420, a graph database 430, a summary database 440, a network interface 450, and a user interface 460.

The processor 410 is configured to process documents stored in the document database 420 in order to automatically generate summaries of those documents, which are then stored in the summary database 440. In some examples, the processor 410 identifies a subset of documents in the document database 420 relating to or discussing one or more topics of interest. Documents may be provided to the system 400 (e.g., for storage in the document database 420) via the network interface 450.

Within those documents, the processor 410 is configured to identify candidate summary sentences satisfying one or more predefined criteria. Candidate summary sentences may be those sentences having or containing a grammatical structure, length, format, or other aspect that has been identified as being characteristic of sentences suitable for use in a summary document.

In one example, the one or more criteria may include particular grammatical structures (such as a verb root and noun or pronoun direct object of the sentence) being present in the candidate summary sentences. The processor 410 may identify and tag the parts of speech within a sentence or to determine if a text string is a known word. In another example, the presence of certain words or phrases may be used by the processor 410 to qualify or disqualify candidate summary sentences. In some examples, “stop words” or phrases” having a known low value for summarizing the document (e.g., “click here” or “Like us on Facebook”), or other features (bullet point lists) may indicate that the substance of the sentence is not summary-worthy. In another example, the length of the sentence may indicate that the sentence is too long to be included in an automated document summary. In another example, the length of the sentence or the presence of formatting element (such as list item identifiers) may indicate that that the sentence is of a type (e.g., a list item) that is not suited for inclusion in a document summary.

The processor 410 may determine at least one content feature of the document from the plurality of candidate summary sentences. The content feature may represent a concept, entity, or topic or subject as represented by one or more syntactic structures in the document (e.g., groupings of words). Such syntactic structures may be defined by the presence and/or proximity of one or more terms, which may use wildcard characters. Content features may include the syntactic structures themselves, as well. In one embodiment, the content feature may be a concept or meaning-loaded entity (MLE) as discussed above.

The processor 410 is also configured to generate a graph of relationships among the plurality of candidate summary sentences is generated. In the graph, each respective relationship in the plurality of relationships represents at least one content feature common to two candidate summary sentences. The graph may be stored by the processor 410 in graph database 430.

The graph may be represented in the graph database 430 as having a number of nodes connected to one another by edges. Each node represents a candidate summary sentence, and each edge represents a relationship between two candidate summary sentences. In one example, the presence of an edge between two candidate summary sentences may indicate that the two sentences contain some number of overlapping (i.e., common) content features. In another example, the edge may have an associated “weight” value representing the strength or depth of the relationship between the two candidate summary sentences. For example, values stored in association with an edge may represent the number of overlapping content features between the two candidate summary sentences, or the strength or relative importance of the overlapping content features.

The processor 410 orders the plurality of candidate summary sentences based on at least one relationship involving a respective candidate summary sentence. The ordering may be based on the relatedness of each candidate summary sentence to the other candidate summary sentences in the document, with those documents most related to others given the highest rank in the ordering. Relatedness may be determined by the number and strength of edges connecting a candidate summary sentence to all other sentences in the document. A high number and/or weight of edges for a particular candidate summary sentence suggests that one sentence may discuss a relatively high number of (possibly) important content features, thereby suggesting that the candidate summary sentence may provide a good summary or overview of those topics and/or how they relate to one another.

In some embodiments, the conceptual importance or “prestige” of the related sentences—the nodes of the graph—may also be taken into account when determining the relatedness of sentences. For purposes of evaluating the relatedness of a sentence to other sentences in the document, a related sentence that discusses a relatively important content topic may accord the sentence being evaluated with a higher prestige score than a related sentence that discusses a relatively less important content topic. The relative importance of content topics may be determined from a training set, and used to assign prestige scores to nodes. For example, the overall frequency of occurrences of a topic in a corpus of training documents may be used to determine a relative importance or “prestige” of each topic, with more frequently-discussed topics being considered more important. That relative importance or prestige may then be considered when the determining the relevance of a sentence discussing that topic in the “live” set of documents.

The relative importance of content topics may also be determined with reference to the location in the document and/or document metadata of the text relating to the content topic. Topics discussed in a title or abstract of a document may be presumed to be more important than those appearing in the middle of the document, for example.

The processor 410 generates a document summary from the candidate summary sentences most related to other candidate summary sentences in the document, and stores the document summary in the document summary database 440. The most highly related sentences may be collected and aggregated until their collective length reaches or exceeds a particular threshold set for document summaries. In some embodiments, the prestige score of a sentence's relationship-partner sentences is also taken into account. For example, a document summary may be generated from the candidate summary sentences with the most relationships centered on the most important topics with the most prestigious relationship partners. For example, the most related sentence, the second most related sentence, and so on may be selected for inclusion in the summary until their total length reaches a defined limit (e.g., 200 characters), at which point no further candidate summary sentences are selected for inclusion.

The processor 410 assembles the document summary from the selected candidate summary sentences. In one embodiment, the actual order of the selected candidate summary sentences within the summary is determined by their relative ordering in the document for which the summary is being generated—i.e., the selected candidate summary sentence that appears earlier in the document than the other selected candidate summary sentences would be the first sentence of the document summary, and so forth.

The processor 410 uses those document summaries generated to generate a meta-document summary of the documents, which may also be stored in the summary database 440. For example, a meta-document may be generated from a plurality of document summaries of the plurality of documents. The meta-document may include all of the sentences of all of the document summaries of the documents in a subset of a documents relating to a topic.

The processor 410 may determine at least one content feature of the meta-document. As discussed above, a content feature may represent a concept, entity, or topic or subject as represented by one or more syntactic structures in the meta-document (e.g., groupings of words). Such syntactic structures may be defined by the presence and/or proximity of one or more terms, which may use wildcard characters. Content features may include the syntactic structures themselves, as well. Content features may be identified through the use of machine learning tool that have been trained on sets of documents known to contain certain content features. Such training sets may be created manually by a knowledgeable user. In one example, documents to be included in training sets may be identified with reference to MLEs that have been tagged in the document.

A graph of a plurality of relationships among the plurality of meta-document sentences is generated by the processor 410. Each respective relationship in the plurality of relationships represents at least one content feature common to two meta-document sentences. The graph may be represented as having a number of nodes connected to one another by edges. Each node represents a sentence of the meta-document, and each edge represents a relationship between two sentences. In one example, the presence of an edge between two meta-document sentences may indicate that the two sentences contain some number of overlapping (i.e., common) content features. In another example, the edge may have an associated “weight” value representing the strength or depth of the relationship between the two sentences. Nodes of the graph representing related sentences may also have a weight reflecting the prestige score of those sentences, as determined by the relative important of the content and/or topics discussed in those related sentences. For example, values stored in association with an edge may represent the number of overlapping content features between the two sentences, or the strength or relative importance of the overlapping content features. In some embodiments, the processor 410 may generate the graph using LexRank, Latent Semantic Indexing, or other libraries or techniques.

The processor 410 may order the plurality of meta-document sentences based on at least one relationship involving a respective meta-document sentence. The ordering may be based on the relatedness of each meta-document sentence to the other meta-document sentences in the meta-document, with those sentences most related to others given the highest rank in the ordering. Relatedness may be determined by the number and strength of edges connecting a meta-document sentence to all other sentences in the meta-document. A high number and/or weight of edges for a particular meta-document sentence suggests that particular sentence may discuss a relatively high number of (possibly) important content features, thereby suggesting that the meta-document sentence may provide a good summary or overview of those content features found in the documents on which the meta-document is based, and/or how those content features relate to one another.

The processor 410 generates a meta-document summary (i.e., a search summary report) from the ordered plurality of meta-document sentences. The meta-document summary includes the meta-document sentences most related to other meta-document sentences in the plurality of meta-document sentences. The most highly related sentences may be collected and aggregated until their collective length reaches or exceeds a particular threshold set for search summary reports. For example, the most related sentence, the second most related sentence, and so on may be selected for inclusion in the summary until their total length reaches a defined limit (e.g., 500 characters), at which point no further meta-document summary sentences are selected for inclusion.

The processor 410 then assembles the search summary report from the selected candidate summary sentences. In one embodiment, the actual order of the meta-document sentences within the search summary report is determined by the ordering of the documents in the topical document list; sentences may be included in the order in which the document from which they are derived appears in the topical document list. Other methods could also be used for ordering the sentences in the search summary report, such as ordering by the strength of the edges between the sentences, calculating the importance of each sentence, and using that importance for ordering the sentences. When several document summaries are used to generate the search summary report, sentences from those document summaries may be selected according to an ordering of the documents themselves. In other words, document summaries may be ordered based on an attribute of the underlying document, and the search summary report may be generated from the ordered document summaries. Documents may be ordered based on such factors as their relevance to a search query, or according to their creation or publication date. In some examples, a two-step ordering of selected candidate summary sentences may be performed. In a first step, candidate sentences are grouped by document in the order of the list of documents. In a second step, the candidate sentences are ordered within the document group according to how they appear in the document.

The document database 420, graph database 430, and summary database 440 store, retrieve and provide information constituting or relating to the documents, including information provided through network interface 450. In some embodiments, this information is stored in one or more relational or non-relational database tables or structures, such as documents. The document database 420, graph database 430, and summary database 440 may take the form of any logical and physical construction capable of storing information on a computer readable medium including flat files, indexed files, hierarchical databases, relational databases and/or object oriented databases. The data may be modeled using unique and foreign key relationships and indexes. The unique and foreign key relationships and indexes may be established between the various fields and tables to ensure both data integrity and retrieval speed.

A user interface 460 (e.g., a graphical user interface) may also be provided that allows a user to interact with any of the system components. For example, the user interface 460 may provide functionality for viewing documents and generating and/or reviewing document summaries and meta-document summaries.

Information may flow between these components and subsystems using any technique known in the art. Such techniques include passing the information over the network via TCP/IP, passing the information between modules in memory and passing the information by writing to a file, database, or some other non-volatile storage device.

What is claimed is:

1. A computer-based method for automatically generating a summary of a document, the method comprising:
identifying, in a document, a plurality of candidate summary sentences satisfying one or more predefined criteria;
determining, from the plurality of candidate summary sentences, at least one content feature of the document;
generating a graph of a plurality of relationships among the plurality of candidate summary sentences, each respective relationship in the plurality of relationships representing at least one content feature common to two candidate summary sentences;
ordering the plurality of candidate summary sentences based on at least one relationship involving a respective candidate summary sentence; and
generating a document summary from the ordered plurality of candidate summary sentences, the document summary including the candidate summary sentences most related to other candidate summary sentences in the plurality of candidate summary sentences.

2. The computer-based method of claim 1, wherein ordering the plurality of candidate summary sentences based on the at least one relationship involving the respective candidate summary sentence includes:
identifying at least one topic in a related sentence of the respective candidate summary sentence; and
assigning a prestige score to the respective candidate summary sentence based on an importance of the at least one topic in the related sentence.

3. The computer-based method of claim 1, wherein the one or more predefined criteria include one of a requirement that a candidate summary sentence has a verb at the root of a parsing diagram of the sentence, a requirement that the candidate summary sentence has a noun or pronoun as the direct object, a requirement that the candidate summary sentence not include one or more defined substrings, and a requirement that the candidate summary sentence does include at least one defined substring.

4. The computer-based method of claim 1, wherein the at least one content feature is at least one of an entity, concept, or linguistic structure.

5. The computer-based method of claim 1, wherein the graph comprises a plurality of nodes and edges, each respective node representing a candidate summary sentence and each respective edge representing a relationship between a first candidate summary sentence and a second candidate summary sentence.

6. The computer-based method of claim 5, wherein each respective edge represents a strength of the relationship between the first candidate summary sentence and the second candidate summary sentence.

7. The computer-based method of claim 6, wherein the strength of the relationship is determined based at least in part on a number of content features common to the first candidate summary sentence and the second candidate summary sentence.

8. The computer-based method of 6, wherein the strength of the relationship is determined based at least in part on an importance of a content feature common to the first candidate summary sentence and the second candidate summary sentence.

9. The computer-based method of claim 1, wherein generating the document summary from the ordered plurality of candidate summary sentences comprises including the candidate summary sentences in an order in which the candidate summary sentences appear in the document.

10. A computer-based method for generating a search report summary comprising:
identifying a plurality of documents relating to a topic;
generating a meta-document from a plurality of document summaries of the plurality of documents, the meta-document comprising a plurality of meta-document sentences;
determining at least one content feature of the meta-document;
generating a graph of a plurality of relationships among the plurality of meta-document sentences, each respective relationship in the plurality of relationships representing at least one content feature common to two meta-document sentences;
ordering the plurality of meta-document sentences based on at least one relationship involving a respective meta-document sentence; and
generating a meta-document summary from the ordered plurality of meta-document sentences, the meta-document summary including the meta-document sentences most related to other meta-document sentences in the plurality of meta-document sentences.

11. The computer-based method of claim 10, wherein ordering the plurality of meta-document sentences includes:
identifying at least one topic in a related sentence of the respective meta-document sentence; and
assigning a prestige score to the respective meta-document sentence based on an importance of the at least one topic in the related sentence.

12. The computer-based method of claim 10, wherein identifying the plurality of documents relating to the topic includes identifying documents having a relevance to the topic at least as high as a defined relevance threshold.

13. The computer-based method of claim 10, wherein the at least one content feature is at least one of an entity, concept, or linguistic structure.

14. The computer-based method of claim 10, wherein the graph comprises a plurality of nodes and edges, each respective node representing a meta-document sentence and each respective edge representing a relationship between a first meta-document sentence and a second meta-document sentence.

15. The computer-based method of claim 14, wherein each respective edge represents a strength of the relationship between the first meta-document sentence and the second meta-document sentence.

16. The computer-based method of claim 15, wherein the strength of the relationship is determined based at least in part on a number of content features common to the first meta-document sentence and the second meta-document sentence.

17. The computer-based method of claim 15, wherein the strength of the relationship is determined based at least in part on an importance of a content feature common to the first meta-document sentence and the second meta-document sentence.

18. The computer-based method of claim 10, wherein generating the document summary from the ordered plurality of candidate summary sentences comprises including the candidate summary sentences in an order in which the candidate summary sentences appear in the document.

19. A computer system for automatically generating a summary of a document, the computer system comprising:
a processor; and
a memory communicatively coupled to the processor and comprising instructions that when executed by the processor cause the processor to
identify, in a document stored in the memory, a plurality of candidate summary sentences satisfying one or more predefined criteria;
determine, from the plurality of candidate summary sentences, at least one content feature of the document;
generate a graph of a plurality of relationships among the plurality of candidate summary sentences, each respective relationship in the plurality of relationships representing at least one content feature common to two candidate summary sentences;
order the plurality of candidate summary sentences based on at least one relationship involving a respective candidate summary sentence; and
generate a document summary from the ordered plurality of candidate summary sentences, the document summary including the candidate summary sentences most related to other candidate summary sentences in the plurality of candidate summary sentences.

20. The computer system of claim 19, wherein the processor is further configured to order the plurality of candidate summary sentences based on the at least one relationship involving the respective candidate summary sentence by being configured to:
identify at least one topic in a related sentence of the respective candidate summary sentence; and
assign a prestige score to the respective candidate summary sentence based on an importance of the at least one topic in the related sentence.
